(19) United States
(12) Patent Application Publication
(10) Pub. No.: US 2013/0275213 A1
(43) Pub. Date: Oct. 17, 2013

(54) SOCIAL MARKETPLACE APPARATUS AND METHOD

(71) Applicant: MASTERCARD INTERNATIONAL INCORPORATED, Purchase, NY (US)

(72) Inventors: Donghao Huang, Singapore (SG); Jie Zhang, Singapore (SG); Bensam Joyson, Singapore (SG); Ross Finch, Singapore (SG); Thomas Dung Dao Xuan, Singapore (SG); Rakesh Chauhan, Singapore (SG); Saurav Ray, Singapore (SG)

(73) Assignee: Mastercard International Incorporated, Purchase, NY (US)

(21) Appl. No.: 13/784,349

(22) Filed: Mar. 4, 2013

Related U.S. Application Data
(60) Provisional application No. 61/625,397, filed on Apr. 17, 2012.

(51) Int. Cl. G06Q 30/02; G06Q 50/00

(52) U.S. Cl. CPC G06Q 30/0255; G06Q 50/01
USPC 705/14.53

(57) ABSTRACT

A system, method, and computer-readable storage medium configured to enable consumers to associate with retail merchants. Product information is received from a user computing device. The product information is matched with promotions and friends that want the product in their wish lists. The user is informed of the promotions and friends, and offered a myriad of options to facilitate product-related transactions with merchants.

### RELATED APPLICATIONS

This application claims priority to provisional U.S. patent application Ser. No. 61/625,397, entitled “Social Marketplace Apparatus and Method,” filed on Apr. 17, 2012.

### BACKGROUND

1. Field of the Invention

Aspects of the disclosure relate in general to social networking. Aspects include a social networking apparatus, system, method and computer-readable storage medium enable bricks-and-mortar retailer and electronic shopping through a social network.

2. Description of the Related Art

A social networking service is an online service platform, or site that focuses on building and reflecting of social networks or social relations among people. The site allows for people who share interests or activities to make their own communities.

A social network service consists of a representation of each user (often a profile) and social links. Most social network services are web-based and allow users to interact over the Internet via e-mail and instant messaging.

Social networking sites allow users to share ideas, activities, events, and interests within their individual networks.

### SUMMARY

Embodiments of the disclosure include a social networking platform to enable consumers to associate with retail merchants. A network interface is configured to receive product information about a product and a user identifier from a user computing device. A processor is configured to match the product information with product promotions stored in a merchant database, resulting in a matched product promotion. The processor further retrieves a list of friends from a social network database using the user identifier, the list of friends having a friend wish list associated with one of the friends. The processor identifies a friend identifier when the product information matches an entry in the friend wish list. The network interface is further configured to transmit to the user computing device the matched product promotion and the friend identifier.

### BRIEF DESCRIPTION OF THE DRAWINGS

FIG. 1 illustrates an embodiment of a system configured to facilitate transactions between consumers and retail merchants via a social media network.

FIG. 2 depicts an embodiment of an apparatus configured to facilitate transactions between consumers and retail merchants via a social media network.

FIG. 3 flowcharts a method embodiment in which retail merchants can store product information into a social network accessed by consumers.

FIG. 4 is a flowchart of a method embodiment in which retail merchants can target product promotion information into a social network accessed by consumers.

FIG. 5 is a flowchart of a method embodiment in which a social network receives consumer wish lists.

FIGS. 6A-B illustrate illustrates a method embodiment in a social network matches a product scan with discounts, promotions, consumer feedback and purchase transactions.

FIG. 7 flowcharts a method embodiment in which a social network matches consumers with nearby retail merchants promoting items on a consumer wish list.

FIG. 8 flowcharts a method embodiment in which a social network receives consumer product, offer or merchant feedback and forwards the feedback to a retail merchant or product manufacturer.

### DETAILED DESCRIPTION

One aspect of the disclosure includes enabling small and medium retail enterprises (SME's) to optimize their often limited/non-existent marketing budgets through the harnessing the power of social media. In essence, it enables them to push targeted offers to consumers, build loyalty and gain word of mouth advertising. Embodiments enable retail enterprises to differentiate and compete with larger competitors. These and other benefits may be apparent in hindsight to one of ordinary skill in the art.

Embodiments of the present disclosure include a system, method, and computer-readable storage medium configured to create loyalty programs, send targeted marketing messages, obtain business intelligence for consumers, merchants and manufacturers, and obtain actionable feedback for merchants and manufacturers.

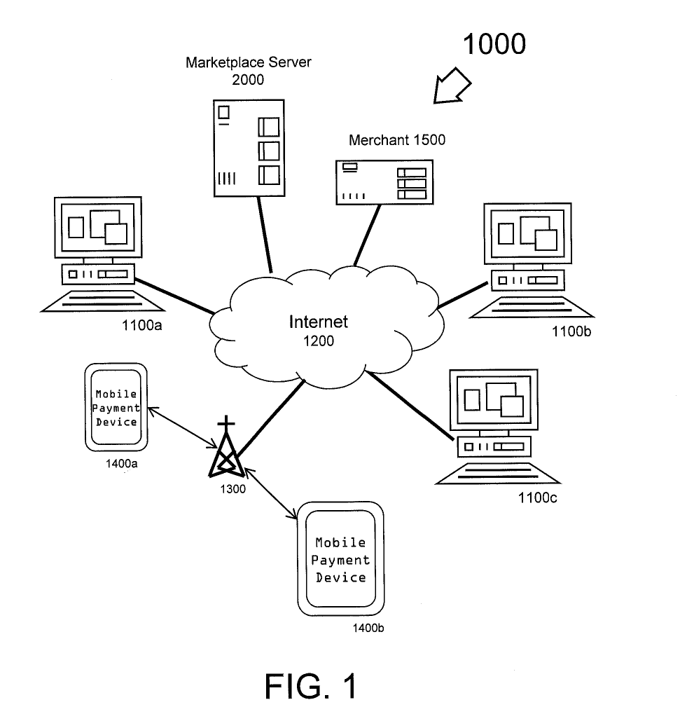

FIG. 1 illustrates an embodiment of a system 1000 configured to facilitate transactions between consumers and retail merchants via a social media network, constructed and operative in accordance with an embodiment of the present disclosure. System 1000 includes consumers using a plurality of computing devices 1100a-c to connect to a marketplace server 2000 via a data network 1200, such as the Internet. Details and example uses of marketplace server 2000 are discussed below.

In some embodiments, consumers may use mobile computing devices 1400a-b and connect to marketplace server 2000 via a wireless data network 1300 capable of connecting to the Internet. It is understood that wireless data network 1300 may be a wireless data provider such as a cellular telephone network, wireless local area network (WLAN or “WiFi networks”), satellite data networks, and the like. Mobile computing devices 1400 include mobile telephones, tablet computers, laptop computers, “ultra books” or other portable computing device known in the art capable of communicating to marketplace server 2000.

In yet other embodiments, merchant 1500 may have its own computing server 1500, or may not have an on-line presence at all.

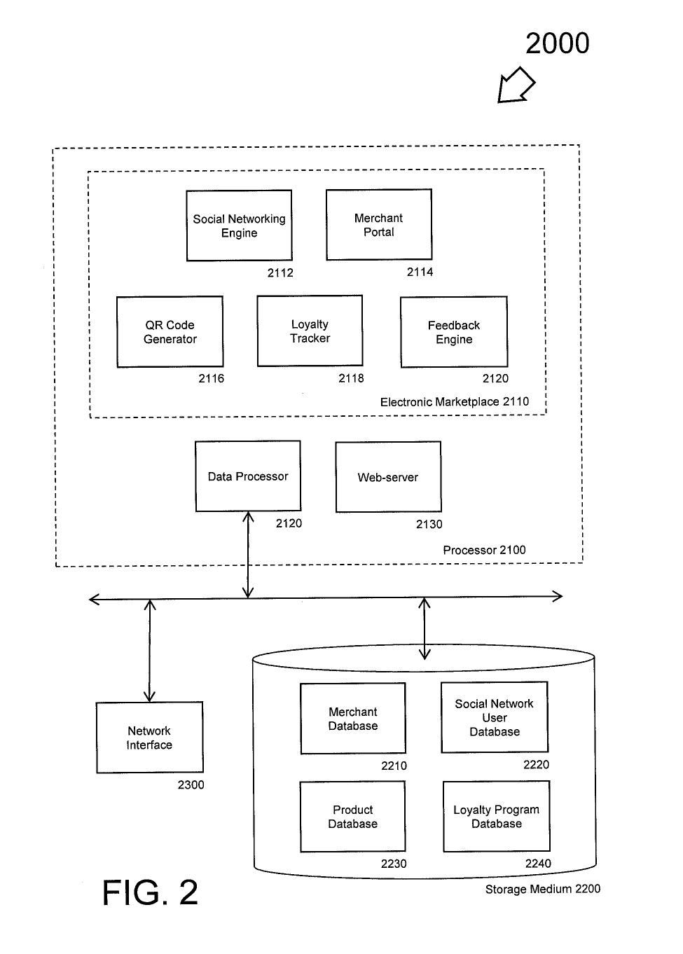

Embodiments will now be disclosed with reference to a block diagram of an exemplary marketplace server 2000 of FIG. 2, constructed and operative in accordance with an embodiment of the present disclosure. Marketplace server 2000 is configured to facilitate transactions between consumers and retail merchants via a social media network.

Marketplace server 2000 may run a multi-tasking operating system (OS) and include at least one processor or central processing unit (CPU) 2100, a computer-readable storage medium 2200, and a network interface 2300.

Processor 2100 may be any central processing unit, microprocessor, micro-controller, computational device or circuit known in the art.

It is well understood by those in the art, that the elements of FIG. 2 may be implemented as hardware, firmware, or as software instructions and data encoded on a computer-readable storage medium 2200.

As shown in FIG. 2, processor 2100 is functionally comprised of an electronic marketplace 2110, a web-server 2130, and a data processor 2120.

Electronic marketplace 2110 may further comprise: social networking engine 2112, merchant portal 2114, Quick Response Code (QR code) handler 2116, loyalty tracker 2118, and feedback engine 2120. Social networking engine 2112 enables consumers to register and communicate with each other and merchants. Merchant portal 2114 is a customized interface that allows merchants to communicate to the social networking engine 2112 and track and coordinate products stored in databases. QR code handler 2116 creates and manages visible barcodes that allow devices to look up products. Loyalty tracker 2118 enables merchants to create and manage promotional or loyalty reward programs for consumers. Feedback engine 2120 allows consumers to send reviews, comments and criticisms of products, merchants and manufacturers. These structures may be implemented as hardware, firmware, or software encoded on a computer readable medium, such as storage media 2200. Further details of these components are described with their relation to method embodiments below.

Data processor 2120 interfaces with storage media 2200 and network interface 2300. The data processor 2120 enables processor 2100 to locate data on, read data from, and writes data to, these components.

Web-server 2130 is any computing device configured to deliver web pages or other content across the Internet 1200 via network interface 2300.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows marketplace server 2000 to communicate with merchant 1500, consumer 1100, and consumers using mobile payment devices 1400.

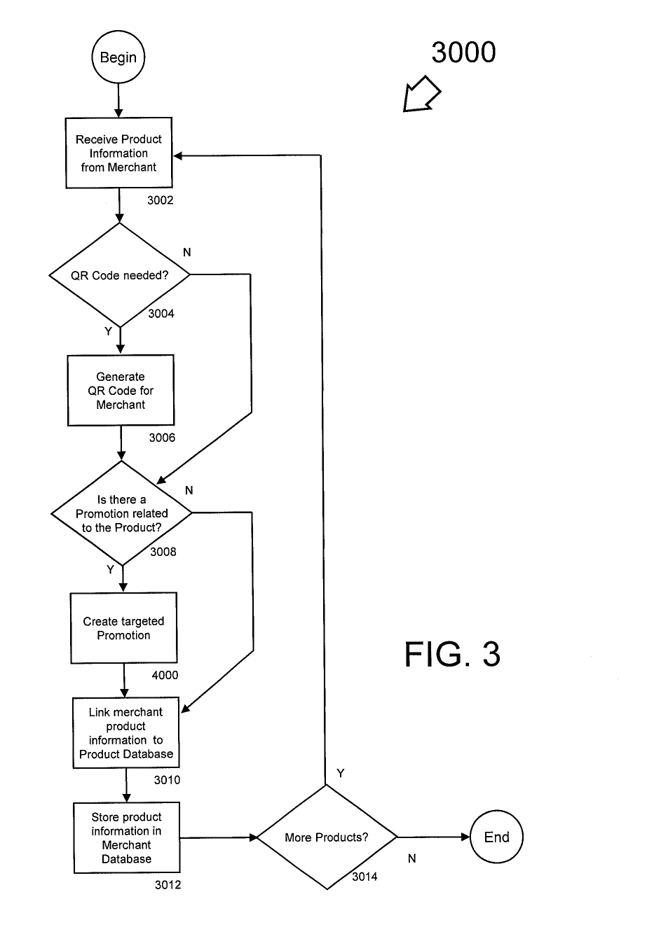

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory or other computer-readable memory device as is known in the art for storing and retrieving data. Significantly, computer-readable storage media 2200 may be remotely located from processor 2100, and be connected to processor 2100 via a network such as a local area network (LAN), a wide area network (WAN), or the Internet 1200. In addition, as shown in FIG. 2, storage media 2200 may also contain a merchant database 2210, a social network user database 2220, a product database 2230, and a loyalty program database 2240. It is understood by those familiar with the art that one or more of these databases 2210-2240 may be combined in a myriad of combinations. The function of these structures may best be understood with respect to the flowcharts of FIGS. 3-8, as described below.

We now turn our attention to method or process embodiments of the present disclosure, FIGS. 3-8. It is understood by those known in the art that instructions for such method embodiments may be stored on their respective computer-readable memory and executed by their respective processors.

FIG. 3 flowcharts a method 3000 in which retail merchants 1500 store product information into a social network marketplace server 2000 accessed by consumers 1100/1400, constructed and operative in accordance with an embodiment of the present disclosure.

At block 3002, merchant portal 2114 receives product information from merchant 1500 via network interface 2300 and the Internet 1200.

Product information includes the title of the product and a sale price.

Depending upon the product proffered for sale, product information may also include a Universal Product Code (UPC), stock-keeping unit (SKU) or a price look-up (PLU) code or other identifier used to identify the product. A Universal Product Code is usually a number that may be encoded as a barcode for tracking products in stores. A stock keeping unit is a number or code used to identify each unique product or item for sale. Price look-up codes identification numbers affixed to products to make check-out and inventory control easier, faster, and more accurate; in many cases, price look-up codes are affixed to produce or other products in grocery stories.

Additionally, product information may include a short description of the product, and other details that relate to a product, such as size, shape, color, quantity, weight or shipping information.

Product information may include reviews of the product by consumers 1100/1400.

It is understood by those familiar with the art that product information may be received in a myriad of different file formats.

If merchant 1500 requests a Quick Response Code for the product, at block 3004, QR code handler 2116 creates a two-dimensional bar code for processing by a barcode reader or mobile payment device 1400 at block 3006. In some embodiments, QR code handler 2116 may generate a standard UPC barcode. Depending upon preferences determined by merchant 1500, the generated bar code may uniquely identify the product, and may also link the product to a particular retail merchant 1500. The barcode is electronically delivered to the merchant for inclusion in advertisements or other promotions.

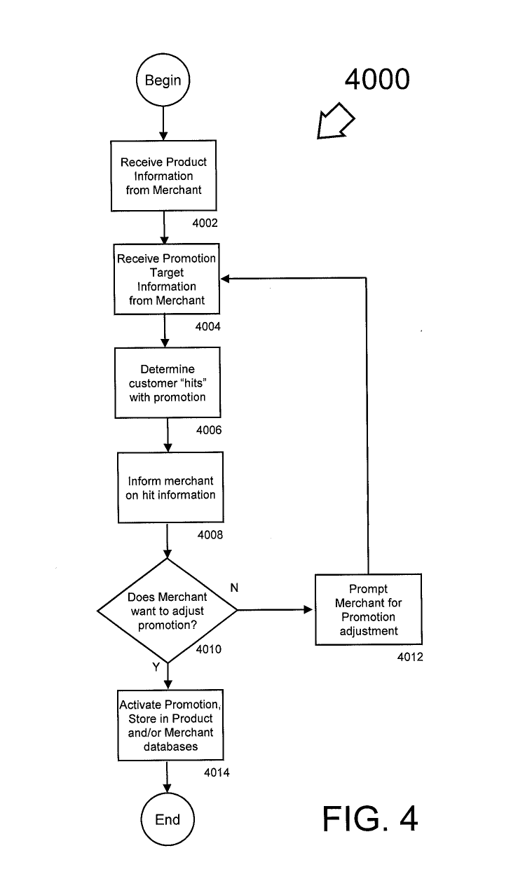

At block 3008, merchant portal 2114 checks whether merchant 1500 would like to create a promotion related to the product. If so, flow continues at process 4000, described in FIG. 4, and then continues to block 3010.

Merchant product information is linked to the product database 2230, and the product is stored in merchant database 3012.

If more products need to be processed, as determined at block 3014, flow returns to block 3002, or otherwise process 3000 ends.

FIG. 4 is a flowchart of a method 4000 in which retail merchants can target product promotion information into a social network accessed by consumers, constructed and operative in accordance with an embodiment of the present disclosure. Creating targeted promotions allows for merchants to maximize their revenue and target customers most likely to make a purchase. Moreover, through analysis of consumer feedback, merchants can obtain sentiment analysis at both a merchant and product level to allow them to adjust their promotional strategies accordingly.

At block 4002, merchant portal 2114 receives product information from merchant. In some embodiments the process 3000 may be used at block 4002. Merchant portal 2114 further receives promotion target information from merchant 1500. Promotion target information is any information used to target specific classes of consumers 1100/1400 to make a purchase at the retail merchant. Example target information may be geographic proximity to a retail merchant store, for example. Other promotion target information may be an electronically published “wish list” by a consumer with the product being promoted. Target information can include “likes” of the product/service/merchant/manufacturer, or “dislikes” of a competitor's product/service. For example, consumers may be targeted because they are close to the merchant hardware store, have a power-tool on their wish list, and a sale is going on at the merchant for power-tools.

In some embodiments, promotions include loyalty points awarded by a loyalty tracker 2118. Such loyalty programs a tracked by a loyalty program database 2240.

Merchant portal 2114 queries the social networking user database 2220 to determine the number of consumer “hits” that meet the promotion target criteria, block 4006, and reports the hits 4008 to merchant 1500. Merchant is given an opportunity to adjust the promotion target criteria, block 4010, if the number of hits is too large, too small or merchant decides to alter the promotion, block 4012.

The promotion is activated at block 4014, and stored in product and/or merchant databases 2210 2230. In some embodiments, consumers that meet the promotion target criteria are automatically alerted about the promotion. Alerts may be through the social networking engine 2112, text or e-mail messages sent to the consumer, or through a custom application (app) running on the mobile payment device 1400.

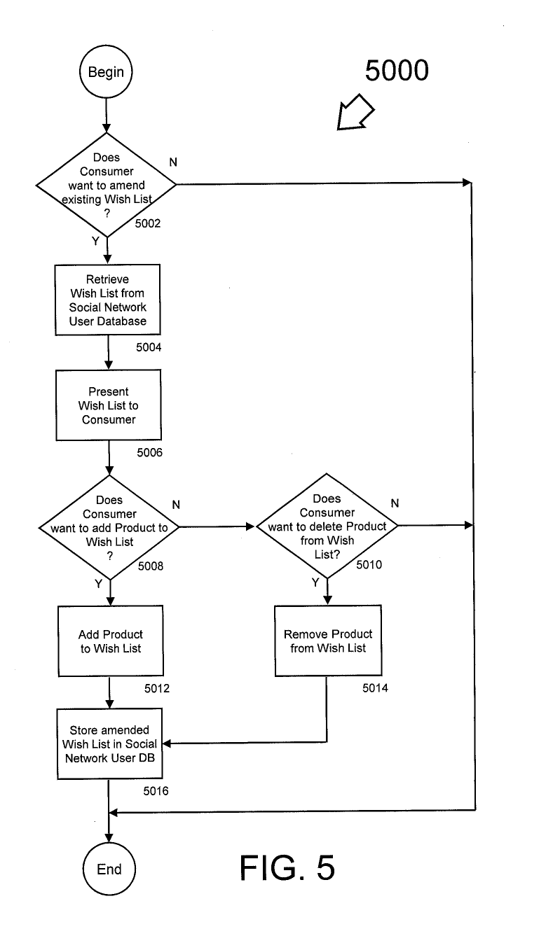

FIG. 5 is a flowchart of a method embodiment in which a social networking engine 2112 receives consumer wish lists, constructed and operative in accordance with an embodiment of the present disclosure. A consumer “wish list” is a database record of products desired by the consumer. In the embodiment described, a user account record within the social network user database 2220 also contains the wish list. The individual product records within the wish list are links to the various desired products in the product database 2230.

When the consumer wants to amend an existing wish list, decision block 5002, social networking engine 2112 retrieves a consumer wish list from the social network user database 2230, block 5004. The wish list is presented to the consumer, block 5006, which allows consumers to add products, block 5008 and 5012, or delete products, block 5010 and 5014 from the wish lists.

The amended wish list is stored in the social network user database 2220.

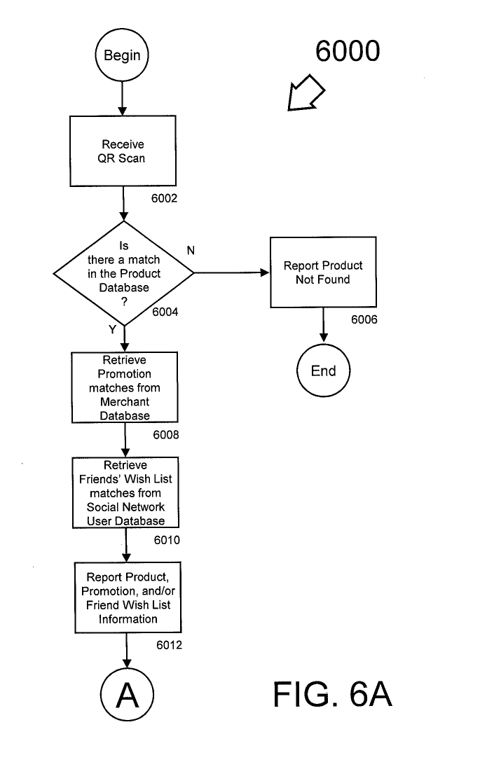

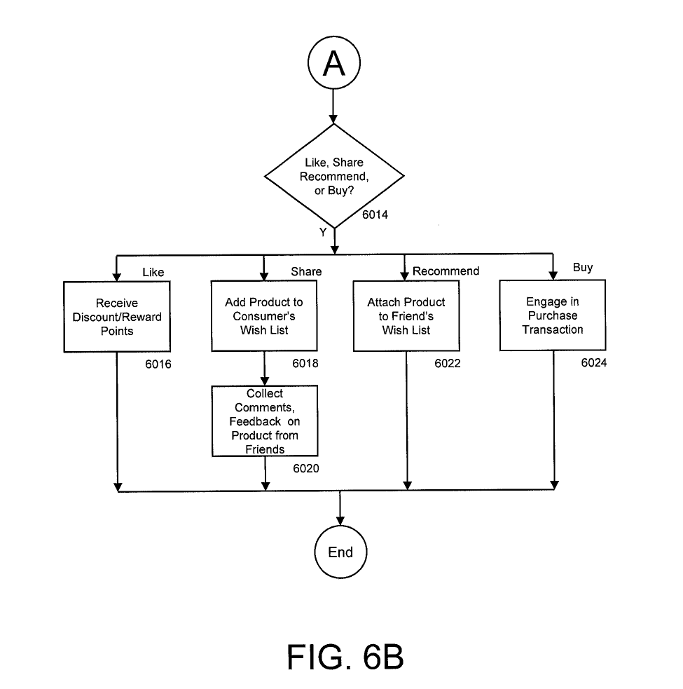

FIGS. 6A-B illustrate a method 6000 in which a social network matches a product scan with discounts, promotions, consumer feedback and purchase transactions, constructed and operative in accordance with an embodiment of the present disclosure. In this example, a mobile payment device 1400 has a QR bar code scanner or the like, and the consumer has scanned a product's QR bar code.

QR code handler 2116 receives the consumer's QR scan at block 6002, and determines whether a match for the scanned product exists in the product database 6004. If no product is found, an error message is reported, block 6006, and process 6000 ends.

If a product match is found, QR code handler 2116 queries merchant database 2210 to determine if any promotional matches are found 6008.

Similarly, QR code handler 2116 queries social network user database 2220 to determine if any friends of the consumer have the product on their wish lists, block 6010.

The results of the queries are reported at block 6012.

The consumer is prompted on whether they like, want to share, recommend, or buy the product, block 6014. It is understood by those in the art, that a subset of these options may be presented to the consumer.

If the consumer chooses to “like” the product, discounts or reward points may be offered by various found promotions, block 6016.

If the consumer chooses to “share” the product, the product is added to their wish list, block 6018, and the consumer is offered the ability to collect comments or feedback on the product from friends 6020.

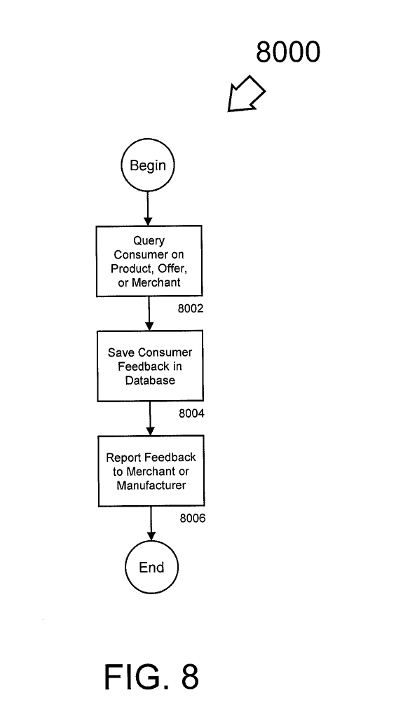

If the consumer chooses to “recommend” the product, the consumer may be prompted to attach the product to a friend's wish list or prompted to review the product, block 6022. In some embodiments, the process 8000 of FIG. 8 may be prompted at this point.

If the consumer chooses to “buy” the product, the consumer may be prompted to either engage an electronic purchase transaction, block 6024 or may be provided nearby retailer information for the product.

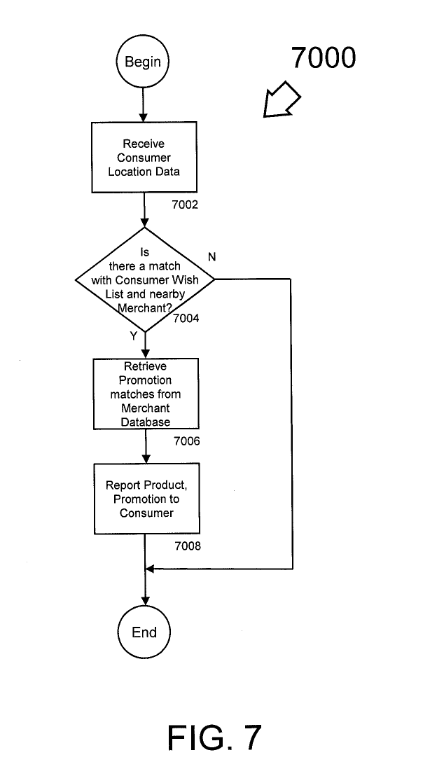

FIG. 7 flowcharts a method embodiment in which a social network matches consumers with nearby retail merchants promoting items on a consumer wish list, constructed and operative in accordance with an embodiment of the present disclosure.

Mobile payment devices 1400 provide consumer location data to an on-board application. The application sends information to electronic marketplace 2110, at block 7002 the location data is received. Social networking engine 2112 queries the merchant database 2210 and the social network user database 2220 to determine whether there is a match with the consumer wish list and a nearby merchant selling the desired product, block 7004.

If there is match, merchant database 2210 is queried to determine any if any active promotions exist for the product, block 7008.

The product promotion information is reported to the consumer 7008 via a notification. The notification may be a text message, a short message service (SMS) message, e-mail, or through an alert through an app running on mobile payment device 1400.

FIG. 8 flowcharts a method embodiment in which a social network receives consumer product, offer or merchant feedback and forwards the feedback to a retail merchant or product manufacturer, constructed and operative in accordance with an embodiment of the present disclosure.

At block 8002, the consumer is prompted for feedback on a product, offer, merchant or manufacturer. Consumer feedback is saved in the product database 2230 or merchant database 2210, block 8004 and reported to the merchant or manufacturer, block 8006.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A social networking platform apparatus comprising:
a network interface configured to receive product information about a product and a user identifier from a user computing device;
a processor configured to match the product information with product promotions stored in a merchant database, resulting in a matched product promotion; the processor further configured to retrieve a list of friends from a social network database using the user identifier, the list of friends having a friend wish list associated with one of the friends; the processor further configured to identify a friend identifier when the product information matches an entry in the friend wish list; and
the network interface is further configured to transmit to the user computing device the matched product promotion and the friend identifier.

2. The apparatus of claim 1,
wherein the network interface is further configured to receive a “like” endorsement from the user computing device; and
wherein the processor is configured to store the “like” endorsement in a wish list associated with the user identifier in the social network database.

3. The apparatus of claim 2, wherein the processor is further configured to award reward points to an account associated with the user identifier.

4. The apparatus of claim 1,
wherein the network interface is further configured to receive a “recommend” endorsement from the user computing device; and
the processor is configured to store the “recommend” endorsement in the friend wish list associated with the friend identifier in the social network database.

5. The apparatus of claim 1,
wherein the network interface is further configured to receive a purchase request for the product from the user computing device; and
wherein the processor is configured to process a payment associated with the purchase request.

6. The apparatus of claim 1, further comprising:
wherein the network interface is further configured to receive a “share” endorsement for the product from the user computing device, and to prompt the list of friends to comment on the product.

7. The apparatus of claim 1, further comprising:
wherein the network interface is further configured to receive location data from the user computing device; and
wherein the processor is configured to determine a merchant selling the product using the location data.

8. A method comprising:
receiving, via a network interface, product information about a product and a user identifier from a user computing device;
matching, with a processor, the product information with product promotions stored in a merchant database, resulting in a matched product promotion;
retrieving a list of friends from a social network database using the user identifier, the list of friends having a friend wish list associated with one of the friends;
identifying, with the processor, a friend identifier when the product information matches an entry in the friend wish list;
transmitting to the user computing device, via the network interface, the matched product promotion and the friend identifier.

9. The method of claim 8, further comprising:
receiving, via the network interface, a “like” endorsement from the user computing device;
storing the “like” endorsement in a wish list associated with the user identifier in the social network database.

10. The method of claim 9, further comprising:
awarding reward points to an account associated with the user identifier.

11. The method of claim 8, further comprising:
receiving, via the network interface, a “recommend” endorsement from the user computing device;
storing the “recommend” endorsement in the friend wish list associated with the friend identifier in the social network database.

12. The method of claim 8, further comprising:
receiving, via the network interface, a purchase request for the product from the user computing device;
processing a payment associated with the purchase request.

13. The method of claim 8, further comprising:
receiving, via the network interface, a “share” endorsement for the product from the user computing device;
prompting, via the network interface, the list of friends to comment on the product.

14. The method of claim 8, further comprising:
receiving, via the user interface, location data from the user computing device;
determining, with the processor and the location data, a merchant selling the product.

15. A non-transitory computer-readable storage medium encoded with data and instructions, that when executed by a social networking platform apparatus, causes the apparatus to:
receive, via a network interface, product information about a product and a user identifier from a user computing device;
match, with a processor, the product information with product promotions stored in a merchant database, resulting in a matched product promotion;
retrieve a list of friends from a social network database using the user identifier, the list of friends having a friend wish list associated with one of the friends;
identify, with the processor, a friend identifier when the product information matches an entry in the friend wish list;
transmit to the user computing device, via the network interface, the matched product promotion and the friend identifier.

16. The non-transitory computer-readable storage medium of claim 15, wherein the instructions further cause the apparatus to:
receive, via the network interface, a “like” endorsement from the user computing device;
store the “like” endorsement in a wish list associated with the user identifier in the social network database.

17. The non-transitory computer-readable storage medium of claim 16, wherein the instructions further cause the apparatus to:
award reward points to an account associated with the user identifier.

18. The non-transitory computer-readable storage medium of claim 15, wherein the instructions further cause the apparatus to:
receive, via the network interface, a “recommend” endorsement from the user computing device;
store the “recommend” endorsement in the friend wish list associated with the friend identifier in the social network database.

19. The non-transitory computer-readable storage medium of claim 15, wherein the instructions further cause the apparatus to:
receive, via the network interface, a purchase request for the product from the user computing device;
processing a payment associated with the purchase request.

20. The non-transitory computer-readable storage medium of claim 15, wherein the instructions further cause the apparatus to:
receive, via the network interface, a “share” endorsement for the product from the user computing device;
prompt, via the network interface, the list of friends to comment on the product.
